(19) United States
(12) Patent Application Publication
(10) Pub. No.: US 2019/0198003 A1
(43) Pub. Date: Jun. 27, 2019

(54) APPARATUS AND METHOD FOR MITIGATING DUMPSTER NOISE

(71) Applicant: Innovative Manufacturing, Inc., Kirkville, NY (US)

(72) Inventor: Donald L. Metz, Kirkville, NY (US)

(21) Appl. No.: 16/233,083

(22) Filed: Dec. 26, 2018

Related U.S. Application Data
(60) Provisional application No. 62/610,151, filed on Dec. 23, 2017.

(51) Int. Cl. G10K 11/162; B65F 3/14

(52) U.S. Cl. CPC G10K 11/162; B65F 3/14

(57) ABSTRACT

A dumpster noise mitigation apparatus includes a lifting fork having a base end configured to attach to a waste collection vehicle, a tip end configured to engage a fork pocket on a dumpster, an upper surface, and a bottom surface. The dumpster noise mitigation apparatus further includes a sound-dampening element secured to one of the upper surface and the lower surface. The sound-dampening element is secured without material removal from the surface of the fork.

### CROSS REFERENCE TO RELATED APPLICATION

Reference is made to and this application claims priority from and the benefit of U.S. Provisional Application Ser. No. 62/610,151, filed Dec. 23, 2017, entitled “APPARATUS AND METHOD FOR MITGATING DUMPSTER NOISE”, which application is incorporated herein in its entirety by reference.

### FIELD OF THE INVENTION

This disclosure relates generally to trash collection and, more specifically, to an apparatus and method for reducing the noise generated when a dumpster is emptied into a garbage truck.

### BACKGROUND OF THE INVENTION

Trash collection has always been a noisy process. For example, a typical front loader garbage truck has two steel lifting forks projecting in front of the truck cab. The forks are connected to steel linkage arms that extend upwards and backwards over the cab, where they are hinged to the container portion of the truck. The driver pulls up to a dumpster, which is typically made of steel, and guides the lifting forks into metal fork pockets on each side of the dumpster. Once positioned, hydraulic actuators rotate the linkage arms to lift the dumpster upwards over the cab and then tip it upside down over the truck's container. The contents of the dumpster then empty into the truck container by gravity. Often, the driver will manipulate the hydraulics to rapidly “shake” the dumpster in an upward and downward motion to dislodge any remaining contents of the dumpster. The collection and emptying of the dumpster is notoriously noisy because the dumpster, forks, and fork pockets are all typically fabricated from high strength steel, resulting in metal-to-metal hammering.

As a result, trash collection companies, municipalities, and the like strive to schedule garbage collection times when it will have the least impact on their customers. In heavily populated areas, such as urban regions or hotels, scheduling collection at night or very early in the morning is discouraged because it may interrupt a customer's sleep. Some areas have enacted local ordinances defining “quiet periods,” during which the trash hauler is prohibited from waste collection. However, scheduling garbage collection later in the day may interfere with local traffic patterns or hotel operations. Thus, trash haulers must strike a balance between efficient routing of the garbage trucks and scheduling collection times that do not negatively impact the local community.

### SUMMARY OF THE INVENTION

In accordance with one aspect of the disclosure, a dumpster noise mitigation apparatus includes a lifting fork having a base end configured to attach to a waste collection vehicle, a tip end configured to engage a fork pocket on a dumpster, an upper surface, and a bottom surface. The dumpster noise mitigation apparatus further includes a sound-dampening element secured to one of the upper surface and the lower surface. The sound-dampening element is secured without material removal from the surface of the fork.

In one embodiment, the dumpster noise mitigation apparatus further includes a slat secured to the lifting fork, and the sound-dampening element is secured to the slat.

In another embodiment, the dumpster noise mitigation apparatus further includes a fork ramp secured to the bottom surface of the tip end of the lifting fork. The fork ramp defines an angled surface extending from the tip end towards the base end.

In accordance with another aspect of the disclosure, a method for reducing the noise generated when a dumpster is emptied into a garbage truck includes the steps of providing a slat in the range of 0.5 inches, providing a sound-dampening element having a thickness in the range of 0.10-0.38 inches, securing the slat to one of an upper surface and a lower surface of a lifting fork, and securing the sound-dampening element to the slat. The step of securing the slat to the fork does not entail material removal from the fork surface.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a side plan view of an exemplary front loader garbage truck positioned to lift a dumpster during a trash collection process;

FIG. 2 depicts a side perspective view of a noise mitigation apparatus in accordance with a first embodiment of the present invention;

FIG. 3 depicts an enlarged view of the noise mitigation apparatus shown in FIG. 2;

FIG. 4 depicts an exploded view of the noise mitigation apparatus shown in FIG. 2;

FIG. 5 depicts an enlarged view of the noise mitigation apparatus shown in FIG. 4;

FIG. 6 depicts a side perspective view of a noise mitigation apparatus in accordance with a second embodiment of the present invention;

FIG. 7 depicts an enlarged view of the noise mitigation apparatus shown in FIG. 6;

FIG. 8 depicts an exploded view of the noise mitigation apparatus shown in FIG. 6;

FIG. 9 depicts an enlarged view of the noise mitigation apparatus shown in FIG. 8;

FIG. 10 depicts a cross-sectional view of the noise mitigation apparatus shown in FIG. 6, taken through the plane labeled 10-10;

FIG. 11 depicts a side perspective view of a noise mitigation apparatus in accordance with a third embodiment of the present invention;

FIG. 12 depicts an exploded view of the noise mitigation apparatus shown in FIG. 11;

FIG. 13 depicts a cross-sectional view of the noise mitigation apparatus shown in FIG. 11, taken through the plane labeled 13-13;

FIG. 14 depicts a cross-sectional view of the sound-dampening element shown in FIG. 13;

FIG. 15 depicts a side perspective view of a noise mitigation apparatus in accordance with a fourth embodiment of the present invention;

FIG. 16 depicts an enlarged view of the noise mitigation apparatus shown in FIG. 15;

FIG. 17 depicts a perspective view of a noise mitigation apparatus in accordance with a fifth embodiment of the present invention;

FIG. 18 depicts an exploded perspective view of the noise mitigation apparatus shown in FIG. 17;

FIG. 19 depicts a block diagram collectively presenting a flow chart illustrating an exemplary embodiment of a process for mitigating noise generated when a dumpster is emptied into a garbage truck; and

FIG. 20 depicts a block diagram collectively presenting a flow chart illustrating another exemplary embodiment of a process for mitigating noise generated when a dumpster is emptied into a garbage truck.

### DETAILED DESCRIPTION OF THE INVENTION

The inventor of the present invention studied the garbage collection noise problem by carefully observing the waste collection process and measuring the sound level. A recorded sound level of 108 dB was not uncommon during the data gathering, that level being equivalent to the sound level of a rock concert, and almost 16 times louder than a household vacuum cleaner or TV audio (70 dB). The inventor noted that the fork pockets are purposely oversized, presumably to prevent binding and to accommodate a wide variety of lifting fork configurations. As a result, there is a large clearance—on the order of several inches—between the fork and the inside surfaces of the rectangular pipe. Consequently, as the linkage arms lift and tip the dumpster from a horizontal position to an upside-down position, the dumpster is afforded a large amount of free movement, and the fork pockets loudly hammer against the lifting forks. The dumpster itself can amplify the sound level, since the dumpster is essentially a cavernous metal box structure. Furthermore, operators that rapidly “shake” the dumpster upward and downward to dislodge any remaining contents can further exacerbate the noise level problem.

Further study revealed that the majority of contact (e.g., banging) occurred against the top and bottom surface of the lifting fork, and to a smaller degree against the sides of the fork. Embodiments of the present invention provide noise mitigation solutions to the observed interaction between the lifting fork and the fork pocket.

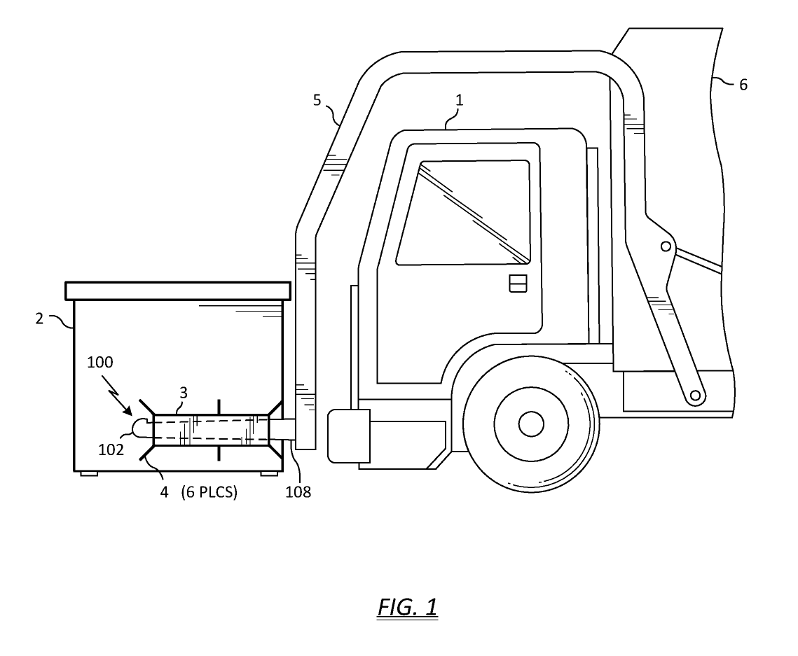

FIG. 1 depicts a front loader waste collection vehicle 1 positioned to lift a dumpster 2 during a trash collection process. The dumpster 2 is equipped with two fork pockets 3 on opposing sides of the dumpster. The fork pockets 3 are typically fabricated from rectangular steel tube, and may be welded to the dumpster bin with support struts 4. The waste collection vehicle 1 includes two opposing linkage arms 5 that extend over the top of the cab, and are hinged to the truck's refuse container 6.

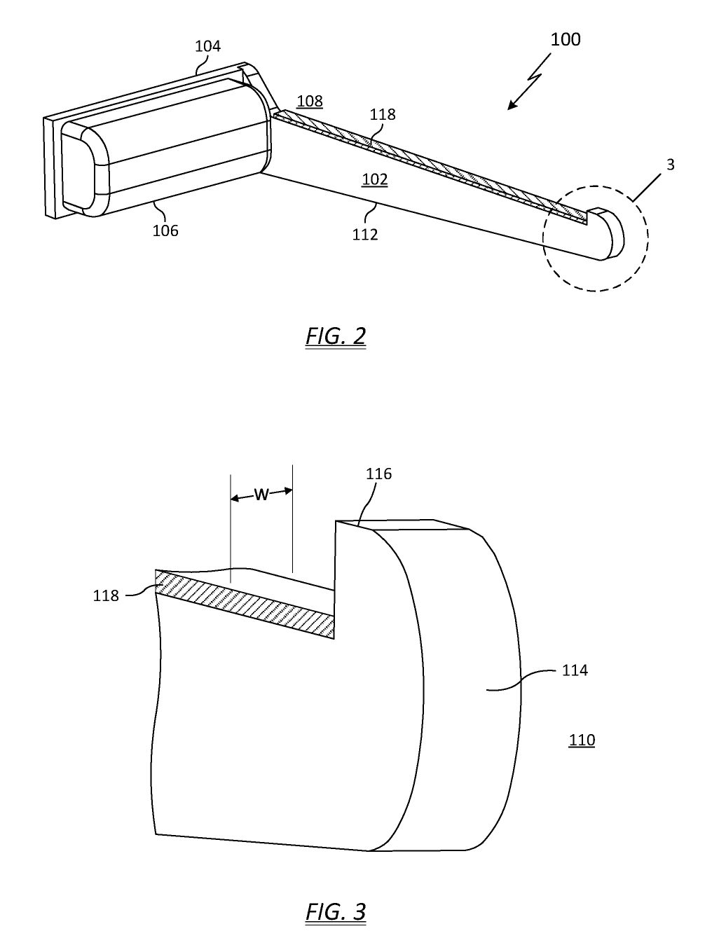

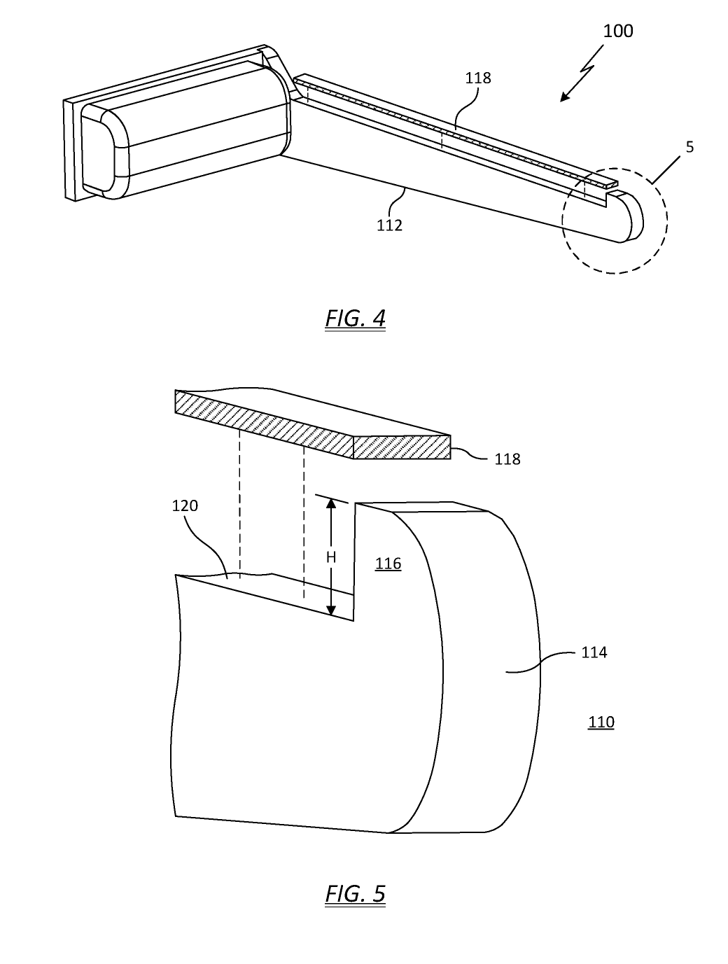

Referring now to FIGS. 1-5, the waste collection vehicle 1 further includes a noise mitigation apparatus 100 to decrease the level of noise generated during the trash collection cycle. The noise mitigation apparatus 100 may include a pair of metal lifting forks 102 projecting in front of the cab of the truck. FIG. 2 depicts the left (driver's side) lifting fork 102, vehicle attachment plate 104, and bumper 106. The lifting forks 102 include a base end 108 that secures to the linkage arms 5 (at the point where they connect to the truck), and an opposing tip end 110 that engages the fork pocket 3 of the dumpster 2. The shape of the lifting forks 102 may vary by vehicle manufacturer, but are generally rectangular, taper from the base to the tip, and are fabricated from steel.

In some examples, the tapering cross section of the fork is approximately square in shape, such that the horizontal and vertical cross sections are alike. In other examples, the tapering cross section of the fork is such that the horizontal cross section of the fork is smaller in dimension than the vertical cross section.

In the illustrated embodiment of the invention, the lifting forks 102 are tapered along a bottom surface 112 from the base end 108 to the tip of the forks such that the forks' vertical dimension is constantly changing along their length. The fork width (W) remains constant along the length of the forks on any particular truck but the width of the forks may vary from manufacturer to manufacturer.

The tip end 110 of the lifting fork 102 may include a rounded nose 114 and a vertically extending lip portion 116 that stops the dumpster fork pocket 3 from sliding off the fork. In one example, the height (H) of the lip portion 116 is approximately 1.50-1.75 inches.

The noise mitigation apparatus 100 further includes a sound-dampening element 118 secured to a surface of the lifting fork 102. In the illustrated embodiment, the sound-dampening element 118 is secured to an upper surface 120 of the lifting fork 102. However, it is contemplated the sound-dampening element 118 could also be secured to a bottom surface 112 of the fork.

In one embodiment of the invention, the sound-dampening element 118 may be fabricated from conveyor belt material, trimmed to the width (W) of the fork and secured with epoxy adhesive. In one example, the belt material may be a multi-ply construction, having an abrasion-resistant upper layer to withstand the day-to-day impacts with the dumpster fork pocket 3, and a matte or roughened bottom layer for better adhesion. Non-limiting examples of the top layer material may include black rubber, nitrile (NBR) impregnated polyester, or polyvinylchloride (PVC). Non-limiting examples of the bottom layer material may include interwoven fabric, monofilament fabric, polyethylene terephthalate (PET) fabric, or non-woven impregnated polyester. In one example, the conveyor belt material may be approximately 0.1 inches thick. In another example, the conveyor belt material thickness may be in a range between 0.10 and 0.25 inches. The sound-dampening element 118 may be approximately 48 inches in length to substantial cover most of the fork surface.

In another embodiment of the invention, the sound-dampening element 118 may be fabricated from a molded material, such as neoprene or fiber-reinforced neoprene. The material may be molded to size or trimmed to the width (W) of the fork and secured with epoxy adhesive. In one example, the molded sound-dampening element 118 may be 0.125 inches thick, with a rubber hardness of Shore 60A, which is similar to the hardness of a car tire tread. The sound-dampening element 118 may be approximately 48 inches in length to substantial cover most of the fork surface. In another example, the sound-dampening element 118 may be formed from Nylon MD, a nylon and molybdenum disulfide (MoS2) composition designed to improve the mechanical, thermal and lubricity properties of type 6/6 nylon.

In one example, the sound-dampening element 118 may be secured to the surface of the lifting forks 102 by an adhesive, such as an industrial two-part epoxy adhesive. In other examples, the sound-dampening element 118 may be secured to the surface of the lifting forks 102 by fasteners, or straps.

The lifting fork surfaces 120, 112 do not require any exceptional preparation prior to application of the sound-dampening element 118. For example, material removal is not necessary. The lifting fork surfaces 120, 112 may be prepped for bonding simply by a thorough cleaning to remove dirt and oils. The sound-dampening element 118 may be applied to the fork surfaces without interfering with the original functionality of the lifting fork, since the material is fairly thin (e.g., 0.1-0.250 inches) compared to, for example, the height (H) of the lip portion 116 (e.g., 1.625 inches). In other words, the thickness of the sound-dampening element 118 may be only 6%-15% of the lip height, which still leaves ample space for the lip portion 116 to perform its function. It is believed the thickness of the sound-dampening element 118 could be as much as 25% of the lip height without adversely impacting the function of the lip portion 116.

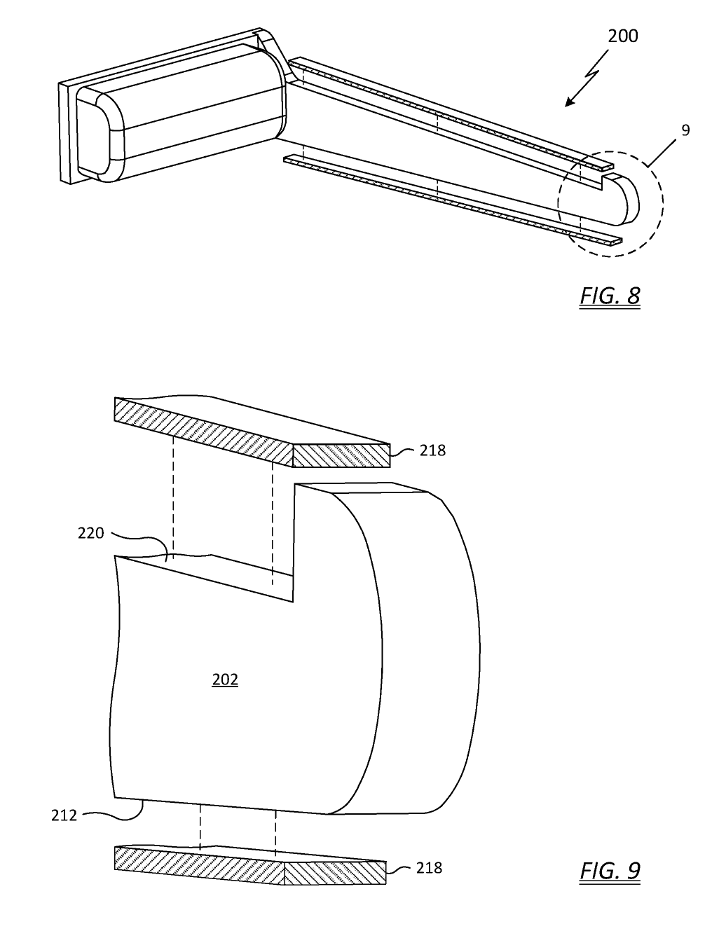

Referring now to FIGS. 6-10, wherein like numerals indicate like elements in FIGS. 1-5, shown is a second embodiment of the present invention in which a noise mitigation apparatus 200 includes a sound-dampening element 218 secured to both an upper surface 220 of the lifting fork 202 and a bottom surface 212 of the lifting fork 202. This configuration, while more expensive to produce and install than the first embodiment, may provide a marked improvement in sound abatement because it prevents metal-to-metal contact with the fork pocket 3 on both top and bottom surfaces of the lifting forks 202, even when the dumpster 2 is tipped upside-down and rapidly shook.

The sound-dampening element 218 may be similar in construction to that disclosed with reference to FIGS. 2-5. That is, in one example, the sound-dampening element 218 may be fabricated from conveyor belt material trimmed to the width (W) of the fork on the bottom surface 212 and the upper surface 220. The belt material may be a multi-ply construction, having an abrasion-resistant upper layer and a matte or roughened bottom layer. The top layer material may include black rubber, nitrile (NBR) impregnated polyester, or polyvinylchloride (PVC), for example. The bottom layer material may include interwoven fabric, monofilament fabric, polyethylene terephthalate (PET) fabric, or non-woven impregnated polyester, for example. The conveyor belt material thickness may be in a range between 0.10 and 0.25 inches.

In another example, the sound-dampening element 218 may be fabricated from a molded material, such as neoprene or fiber-reinforced neoprene. The material may be molded to size or trimmed to the width (W) of the fork (top and bottom) and secured with epoxy adhesive. In one example, the molded sound-dampening element 218 may be 0.125 inches thick, with a rubber hardness of Shore 60A.

The sound-dampening element 218, either the conveyor belt material, molded material, or other material, may be secured to the surface of the lifting forks 202 by an adhesive, such as an industrial two-part epoxy adhesive, or by fasteners or straps. Furthermore, the sound-dampening element 218 may be approximately 48 inches in length to substantial cover most of the upper and bottom fork surfaces.

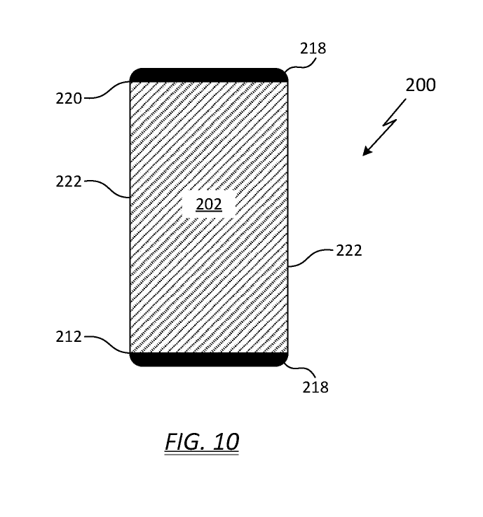

FIG. 10 depicts a cross-sectional view of the noise mitigation apparatus 200 shown in FIG. 6, taken through the plane labeled 10-10. The sound-dampening element 218 is shown applied to the upper surface 220 and the bottom surface 212. In the illustrated example, the sound-dampening element 218 is substantially flush with the side 222 of the lifting fork 202, so as to not overhang.

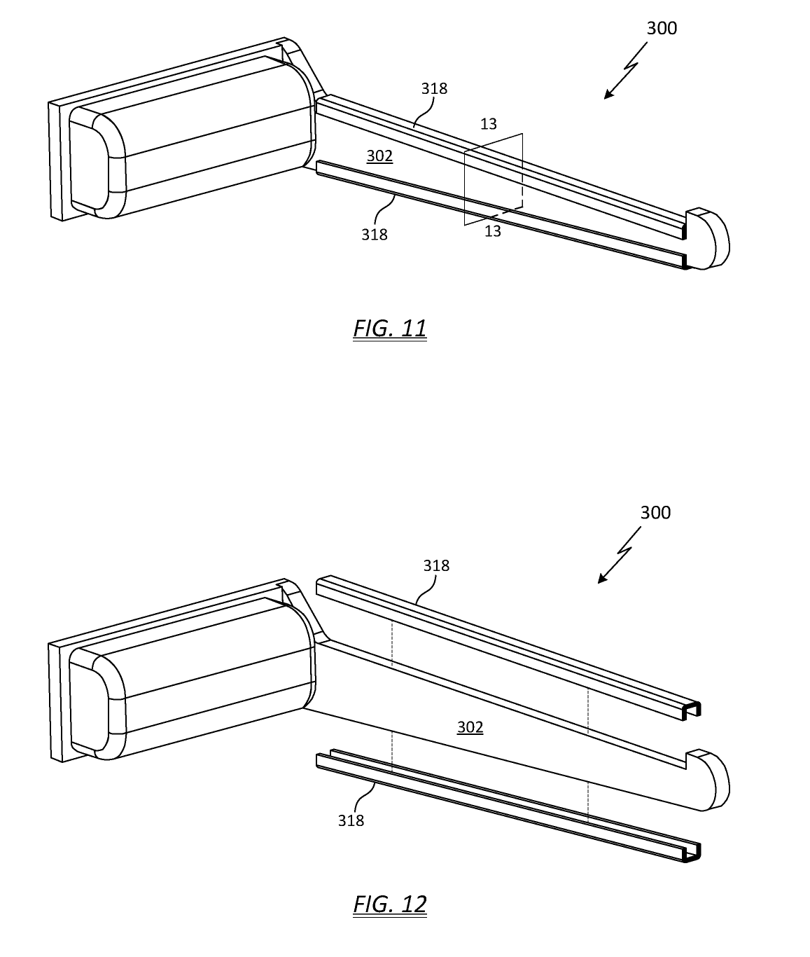

Referring now to FIGS. 11-14, wherein like numerals indicate like elements in FIGS. 1-5, shown is a noise mitigation apparatus 300 with a sound-dampening element 318 having a cross-section that takes the form of a channel. The channel is sized to fit snugly over the upper 320 and side 322 surfaces of the lifting fork 302, and/or the bottom 312 and side 322 surfaces of the lifting forks 302. In the illustrated embodiment, the channel-shaped sound-dampening element 318 is secured to both the upper surface 320 and the bottom surface 312. The sound-dampening element 318 may be fabricated from a molded material, such as neoprene or fiber-reinforced neoprene. In one example, the sound-dampening element 318 may be secured to the lifting forks 302 using an industrial two-part epoxy adhesive. The adhesive may be applied to the lifting fork surfaces 312, 320, and the channel-shaped sound-dampening element 318 may be pushed over the fork and allowed to cure. The sound-dampening element 318 may be clamped in place during cure, if needed.

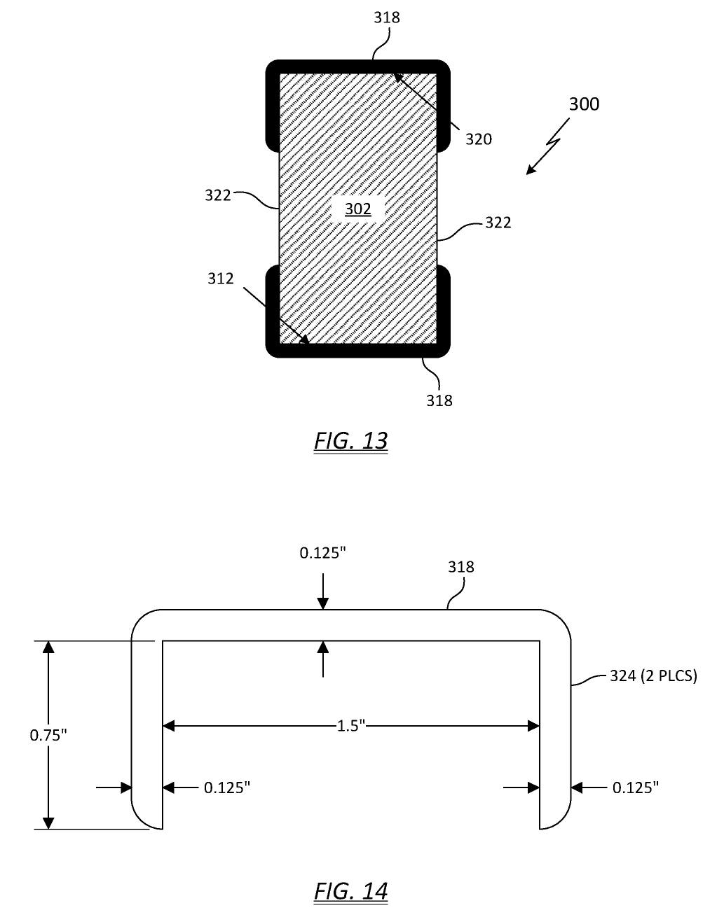

FIGS. 13 and 14 depict cross-sectional views of the channel-shaped sound-dampening element 318. FIG. 14 includes manufacturing dimensions for one exemplary molded channel, which may be approximately 48 inches long. In the given example, all three sides of the channel 318 are about 0.125 inches thick, and the side members 324 extend approximately 0.75 inches along the side 322 of the fork 302.

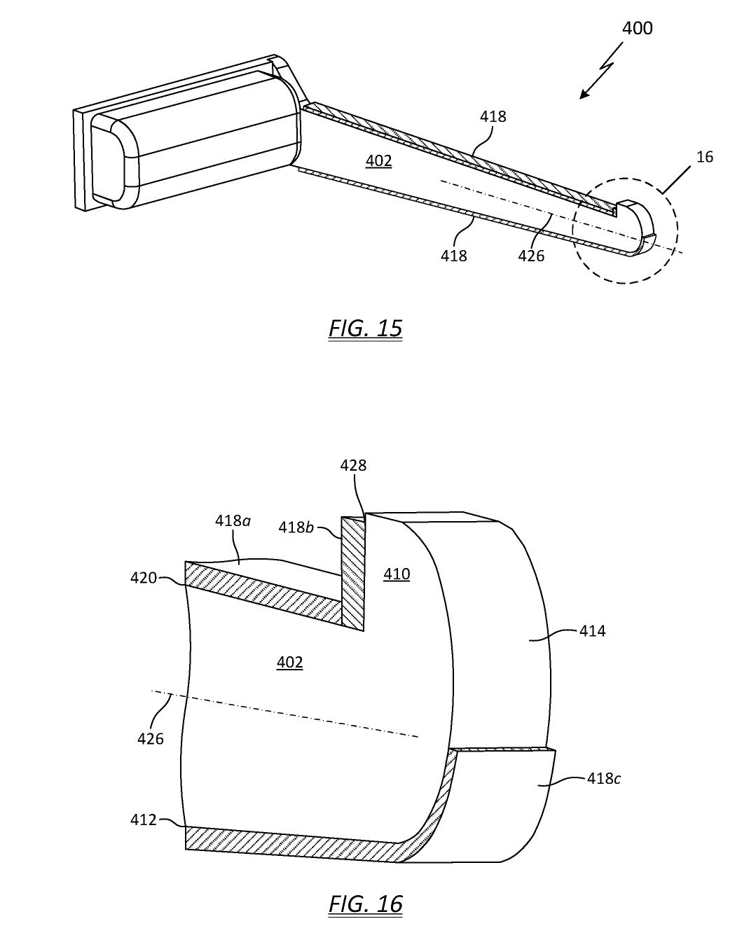

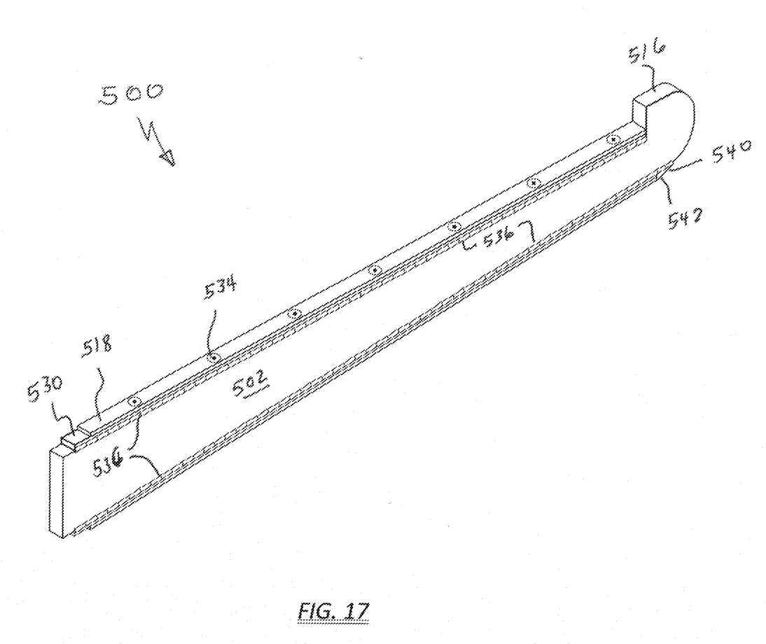

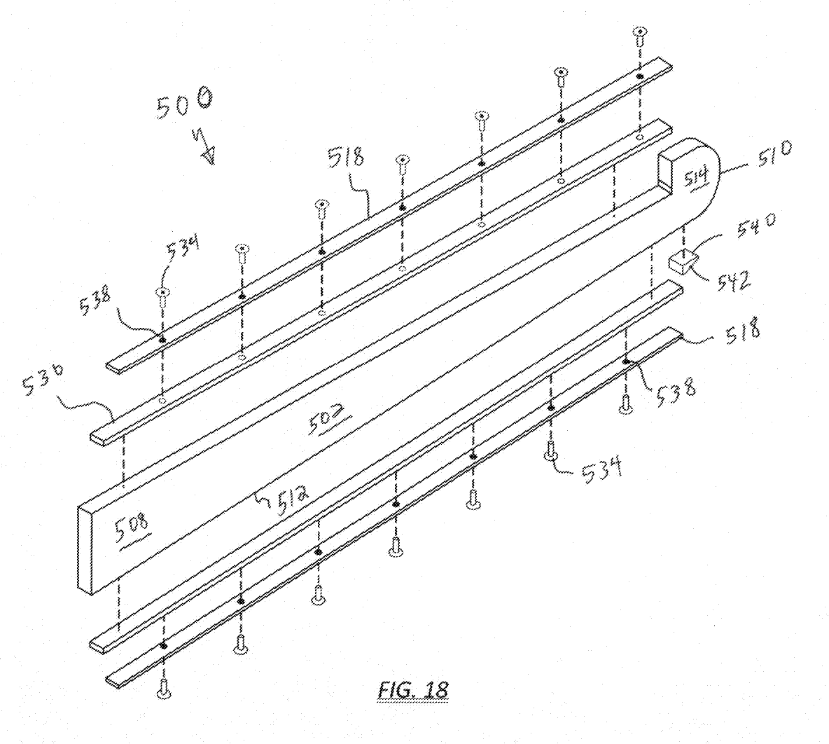

Referring now to FIGS. 15-16, wherein like numerals indicate like elements in FIGS. 1-5, shown is a fourth embodiment of a noise mitigation apparatus 400. In this configuration, the sound-dampening elements 418 can mitigate noise created in a direction along the longitudinal axis 426 of the lifting fork 402. In one example, sound-dampening element 418a can be secured to the upper surface 420 of the lifting forks 402 as previously disclosed herein. Sound-dampening element 418b, which may comprise the same material as element 418a, can be secured to the vertical face 428 of the tip end 410 of the nose 414. The sound-dampening element 418b may be secured in the same manner as element 418a, for example with industrial two-part epoxy adhesive. In the illustrated example, sound-dampening element 418b does not extend vertically farther than the top surface of the tip end 410, and may be configured to extend less than the top surface (e.g., recessed) so as to assure the sound-dampening element 418b does not get peeled or scraped off. One advantage of the additional sound-dampening element 418b is that it can mitigate the noise generated when the vertical face 428 of the fork tip end 410 hammers against the front edge of the dumpster fork pocket 3.

In another example, the noise mitigation apparatus 400 may include a sound-dampening element 418c that extends along the fork bottom surface 412 as previously disclosed herein, but further includes a segment that at least partially covers the nose portion 414 of the lifting fork 402. Sound-dampening element 418c, which may comprise the same material as element 418a, can be secured in the same manner as element 418a, for example with industrial two-part epoxy adhesive. Sound-dampening element 418c can be adapted to mitigate the noise generated when the lifting forks 402 are not properly aligned and subsequently hit the dumpster fork pocket 3. Therefore, to prevent the sound-dampening element 418c from peeling or shearing away from the nose 414 when the fork 402 hits the fork pocket 3, in one example the sound-dampening element 418c extends about half way up the curved surface of the nose. In another example, the sound-dampening element 418c extends approximately one-third up the curved surface of the nose. In yet another example, the sound-dampening element 418c extends between one-third and two-thirds up the curved surface of the nose. And, in yet another example, the sound-dampening element 418c can extend upwards and cover substantially all of the fork nose 414.

One problem identified in engineering development trials of the disclosed invention was that the adhesive used to secure the sound-dampening element to the lifting forks did not endure as long as hoped. As a result, the sound-dampening element needed to be replaced, and the preparation time required to remove the old adhesive became quite consuming.

Experiments were conducted with several combinations of sound-dampening material and commercial adhesives, and although some proved useful and were advantageous for certain applications, a more enduring solution was sought that could be incorporated over a wider range of climate conditions and fork configurations. Furthermore, a sound-dampening element that could be easily removed and replaced was desirable.

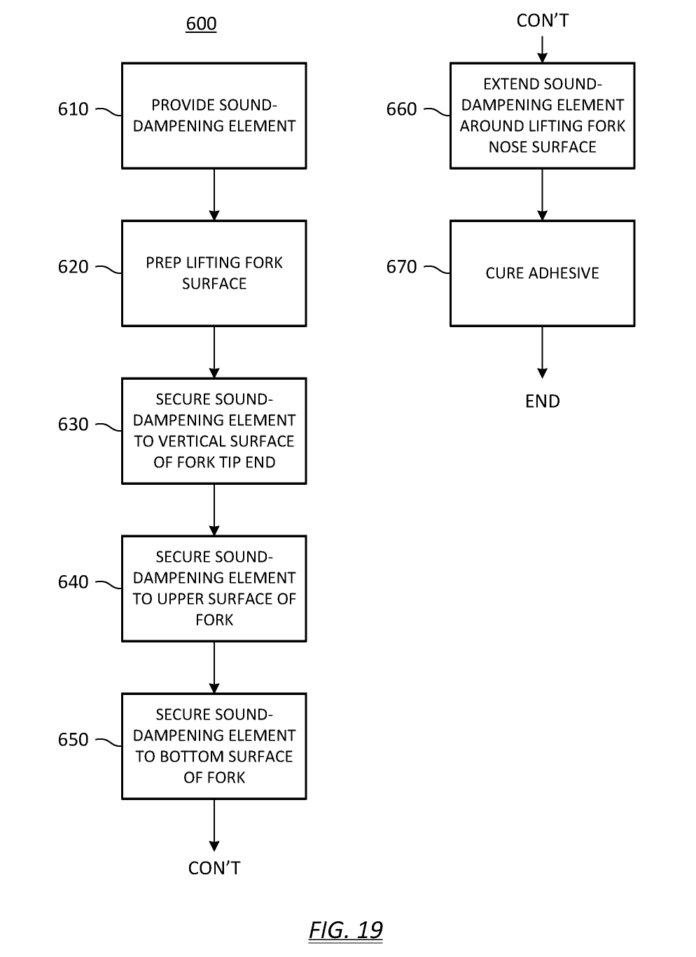

Referring now to FIGS. 17-18, wherein like numerals indicate like elements in FIGS. 1-5, shown is a fifth embodiment of a noise mitigation apparatus 500 that solves the above-noted problems. In this configuration, a slat 530 is secured to the upper surface 520 and/or bottom surface 512 of the lifting fork 502, and a sound-dampening element 518 is secured to the slat. The slat 530 may be configured for long-term or permanent securement to the lifting fork 502, and the sound-dampening element 518 may be configured for easy removal and replacement. In one embodiment, the slat 530 may be formed of metal, sized approximately the same length and width as the fork upper or bottom surface 520, 512, respectively, and may be at least as thick as required for drilled and tapped threaded holes 532. In one example, the slat 530 is 48 inches long, 1 inch wide, 0.50 inches thick, and formed from cold-rolled steel. The slat 530 may further define a pattern of equally-spaced ⅜-16 UNC tapped holes 532 to accommodate a fastener 534, such as a flat head hex socket cap screw.

In one embodiment of the invention, the slat 530 may be permanently secured to the lifting fork 502 by welding it along its side edge, as depicted by the weld seam 536 shown in FIG. 17. Although the lifting fork 502 may be prepared for welding by lightly grinding the upper and bottom surfaces 520, 512 as needed to remove rust, no removal of fork material (i.e., steel) is required in the disclosed embodiment.

In one embodiment of the invention, the sound-dampening element 518 may be formed from Nylon MD, a nylon and molybdenum disulfide (MoS2) composition designed to improve the mechanical, thermal and lubricity properties of type 6/6 nylon. The material may be molded to size or trimmed to the width of the fork. In one example, the sound-dampening element 518 is 48 inches long, 1 inch wide, and 0.38 inches thick. The sound-dampening element 518 may further define a pattern of equally-spaced thru holes 538 to accommodate a fastener 534, such as a flat head hex socket cap screw. In another example, the sound-dampening element 518 may be formed from a molded material, such as neoprene or fiber-reinforced neoprene.

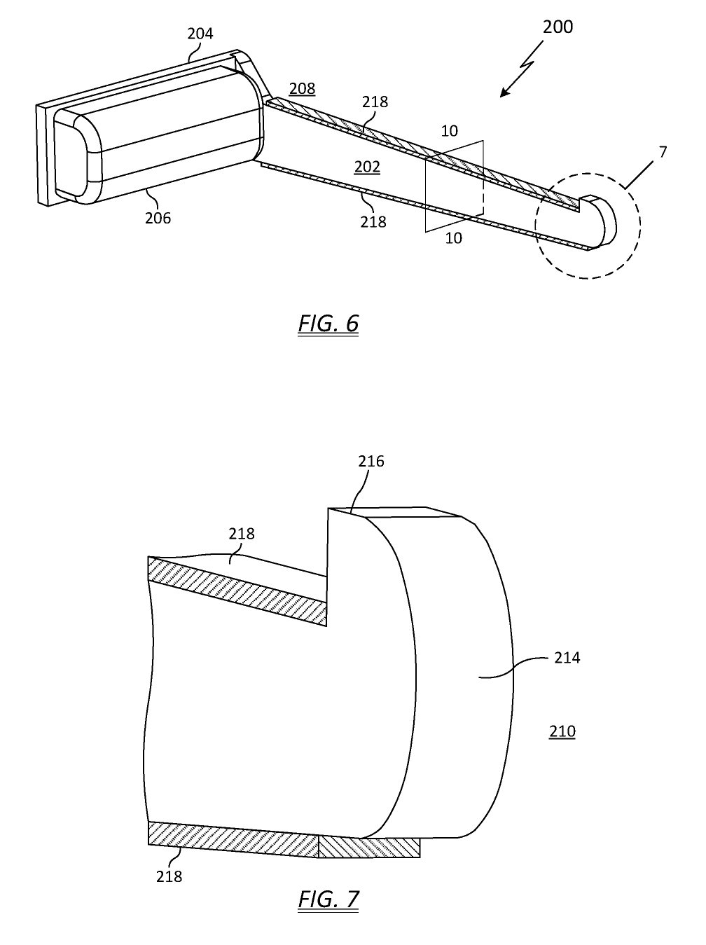

Another problem identified in engineering development trials of the disclosed invention was that, in configurations where there was no lip portion 516 on the fork, the sound-dampening element 518 was battered by the forward edges of the fork pocket 3 (FIG. 1) as the fork engaged the pocket. For example, referring to FIG. 7, the sound-dampening element on the upper surface of the fork remained intact and held up very well with repeated use. However, the sound-dampening element on the bottom surface abraded and/or delaminated from the fork after repeated use, even when wrapped along the nose, as shown in FIG. 16. It is believed the wide variability in which the lifting fork engages the fork pocket (e.g., hitting the upper, lower, or side edges of the pocket) resulted in unanticipated dynamic loads on the sound-dampening element. In some trials, even when the sound-dampening element remained secured to the fork, it abraded to failure.

In one embodiment of the invention, the noise mitigation apparatus 500 may further include a fork ramp 540 and to protect the sound-dampening element 518 and alleviate the abrading problem. In the illustrated embodiment, the fork ramp 540 may be positioned where the fork tip 510 transitions to the bottom surface 512. The fork ramp 540 may include a rounded or angled surface 542 extending from the tip end 510 towards the base end 508. In one example, the angle may be approximately 30 degrees. The height of the fork ramp 540 may be equal to or greater than the combined thickness of the slat 530 and the sound-dampening element 518. In one example, wherein the slat 530 is 0.5 inches thick and the sound-dampening element 518 is 0.38 inches thick, the fork ramp 540 may be 1.5 inches long, 1 inch wide, and 0.88 inches high. The fork ramp 540 may be fabricated from steel and welded to the lifting fork 502, as depicted by the weld seam 536 shown in FIG. 17.

Although the fork ramp 540 is shown protecting the sound-dampening element 518 on the bottom surface 512, it can also protect the sound-dampening element 518 on the upper surface 520 if no lip portion 516 is present.

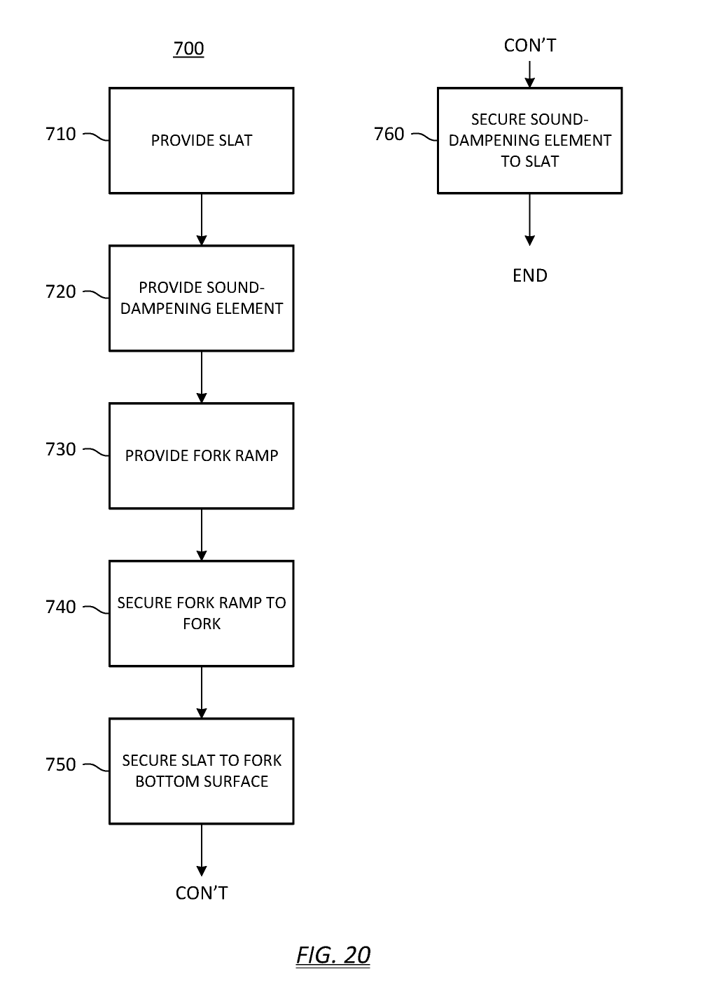

Turning now to FIG. 19, disclosed is a method 600 for reducing the noise generated when a dumpster is emptied into a garbage truck. At step 610, a sound-dampening element is provided for securement to the lifting forks. In one example, the sound-dampening element may be fabricated from conveyor belt material, trimmed to the width of the fork. The conveyor belt material may be approximately 0.1 inches thick. In another example, the sound-dampening element may be fabricated from a molded material, such as neoprene or fiber-reinforced neoprene. The molded sound-dampening element may be approximately 0.125 inches thick, with a rubber hardness of Shore 60A.

The method 600 for reducing the noise generated when a dumpster is emptied into a garbage truck may include a step 620 to prepare the lifting fork surfaces for the securement of the sound-dampening element. In one example, the forks need only be cleaned of dirt and oils prior to application of an epoxy.

The method 600 may further include a step 630 for securing a sound-dampening element to the vertical surface of the fork to end. In one example, the sound-dampening element can be secured with an industrial two-part epoxy adhesive. At the bottom, the sound-dampening element can butt up against the upper surface of the fork. At the top, the sound-dampening element may not extend higher than the flat surface of the tip end of the fork nose. The sound-dampening element may also be recessed from (i.e., lower than) the flat surface of the tip end of the fork nose.

The method 600 may further include a step 640 for securing a sound-dampening element to an upper surface of the lifting fork. In one embodiment of the invention, the width of the element is no more than the width of the fork surface, such that there is no overhang. The sound-dampening element may be secured with an industrial two-part epoxy adhesive, strapped, or fastened. In another embodiment of the invention, the sound-dampening element can have a cross-section that takes the form of a channel, such that it fits snugly over the fork surface.

The method 600 may further include a step 650 for securing a sound-dampening element to a bottom surface of the lifting fork. In one embodiment of the invention, the width of the element is no more than the width of the fork surface, such that there is no overhang. The sound-dampening element may be secured with an industrial two-part epoxy adhesive, strapped, or fastened. In another embodiment of the invention, the sound-dampening element can have a cross-section that takes the form of a channel, such that it fits snugly over the fork surface.

The method 600 for reducing the noise generated when a dumpster is emptied into a garbage truck may include a step 660 to extend the sound-dampening element so as to at least partially cover the forward nose portion of the lifting fork. The sound-dampening element may extend about one-third up the curved surface of the nose. In another example, the sound-dampening element may extend approximately half way up the curved surface of the nose. In yet another example, the sound-dampening element may extend upwards and cover substantially all of the fork nose.

The method 600 may further include a step 670 to cure the industrial two-part epoxy adhesive. During the curing step, the sound-dampening element may be temporarily clamped to assure proper adhesion.

Turning now to FIG. 20, disclosed is a method 700 for reducing the noise generated when a dumpster is emptied into a garbage truck. At a step 710, a slat is provided for permanent securement to the lifting forks. The slat may be formed from cold-rolled steel, sized approximately the same length and width as the fork upper or bottom surface, and may be at least as thick as required for drilled and tapped threaded holes.

At a step 720, a sound-dampening element is provided for securement to the slat. In one example, the sound-dampening element may be fabricated from Nylon MD, trimmed to the length and width of the fork, and may be approximately 0.38 inches thick. The sound-dampening element may further define a pattern of equally-spaced thru holes to accommodate a fastener, such as a flat head hex socket cap screw.

The method 700 may further include a step 730 of providing a fork ramp and a step 740 of securing the fork ramp to the fork. In one example, the fork ramp may be positioned where the fork tip transitions to the bottom surface. The fork ramp may include a rounded or angled surface extending from the tip end towards the base end. In one example, the angle may be approximately 30 degrees. The fork ramp may be welded to the lifting fork along its side edge.

The method 700 may further include a step 750 for securing the slat to the bottom surface of the lifting fork. In one example, the slat may be permanently secured to the lifting fork by seam welding along its side edges.

The method 700 may further include a step 760 of securing the sound-dampening element to the slat. In one example, the securement is provided by flat head hex socket cap screws.

One of the improvements of the disclosed noise mitigation apparatus and method is that the noise generated during dumpster emptying can be reduced by about 10 dB, or 50%. This significant reduction can allow trash haulers to open their schedules and thereby schedule routes more efficiently.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

1. A dumpster noise mitigation apparatus, comprising:
a lifting fork, comprising:
a base end configured to attach to a waste collection vehicle;
a tip end configured to engage a fork pocket on a dumpster;
an upper surface; and
a bottom surface;
and
a sound-dampening element secured to one of the upper surface and the lower surface,
wherein the sound-dampening element is secured without material removal from the surface of the fork.

2. The dumpster noise mitigation apparatus according to claim 1, wherein the sound-dampening element is secured to both the upper surface and the bottom surface.

3. The dumpster noise mitigation apparatus according to claim 1, wherein the lifting fork further includes a rounded nose at the tip end, and a lip portion extending therefrom, and the dumpster noise mitigation apparatus further comprises a sound-dampening element secured to a vertical face of the lip portion.

4. The dumpster noise mitigation apparatus according to claim 1, wherein the lifting fork further includes a rounded nose at the tip end, the sound-dampening element is secured to the bottom surface of the lifting fork, and the sound-dampening element extends from the bottom surface to at least partially cover the nose portion.

5. The dumpster noise mitigation apparatus according to claim 4, wherein the sound-dampening element extends to cover approximately one-third the nose portion.

6. The dumpster noise mitigation apparatus according to claim 4, wherein the sound-dampening element extends to cover approximately one-half the nose portion.

7. The dumpster noise mitigation apparatus according to claim 4, wherein the sound-dampening element extends to cover substantially all of the nose portion.

8. The dumpster noise mitigation apparatus according to claim 1, wherein the sound-dampening element has a cross-section that takes the form of a channel.

9. The dumpster noise mitigation apparatus according to claim 8, wherein the channel cross-section is approximately 0.125 inches thick.

10. The dumpster noise mitigation apparatus according to claim 8, wherein the sound-dampening element has a rubber hardness of Shore 60A.

11. The dumpster noise mitigation apparatus according to claim 1, wherein the sound-dampening element is fabricated from conveyor belt material having a thickness in the range of 0.10-0.25 inches.

12. The dumpster noise mitigation apparatus according to claim 1, further comprising a slat secured to the lifting fork, and the sound-dampening element is secured to the slat.

13. The dumpster noise mitigation apparatus according to claim 12, wherein the slat is formed of steel and is welded to the lifting fork.

14. The dumpster noise mitigation apparatus according to claim 12, wherein the slat defines a pattern of threaded holes, and the sound-dampening element is secured to the slat by one or more fasteners.

15. The dumpster noise mitigation apparatus according to claim 12, further comprising a fork ramp secured to the bottom surface of the tip end of the lifting fork, the fork ramp defining an angled surface extending from the tip end towards the base end.

16. The dumpster noise mitigation apparatus according to claim 15, wherein the fork ramp is welded to the lifting fork.

17. The dumpster noise mitigation apparatus according to claim 15, wherein the height of the fork ramp is equal to or greater than the combined thickness of the slat and the sound-dampening element.

18. A method for reducing the noise generated when a dumpster is emptied into a garbage truck, comprising the steps of:
providing a slat in the range of 0.5 inches;
providing a sound-dampening element having a thickness in the range of 0.10-0.38 inches;
securing the slat to one of an upper surface and a lower surface of a lifting fork;
securing the sound-dampening element to the slat;
wherein the step of securing the slat to the fork does not entail material removal from the fork surface.

19. The method of claim 18, further comprising the step of securing a fork ramp to the one of an upper surface and a lower surface of a lifting fork at a transition of the tip.

20. The method of claim 18, wherein the step of securing the slat comprises welding the slat to the fork.
